(19) United States
(12) Patent Application Publication
(10) Pub. No.: US 2007/0017280 A1
(43) Pub. Date: Jan. 25, 2007

(54) WEAR MONITORING

(76) Inventor: Stephen Richard Scull, Wotton-Under-Edge (GB)

Correspondence Address: SMITH-HILL AND BEDELL, P.C., 16100 NW CORNELL ROAD, SUITE 220, BEAVERTON, OR, 97006, US

(21) Appl. No.: 11/458,151

(22) Filed: Jul. 18, 2006

Related U.S. Application Data
(60) Provisional application No. 60/701,219, filed on Jul. 20, 2005.

(51) Int. Cl. G01M 15/00

(52) U.S. Cl. 73/116

(57) ABSTRACT

Monitoring apparatus 12 for monitoring bearing wear in a large two stroke internal combustion engine 10. The apparatus 12 includes two proximity sensors 14 which are arranged to detect the position of a guide shoe 18 at the bottom dead centre of its stroke. Respective detected positions of the guide shoe 18 over time are compared to provide an indication of bearing wear.

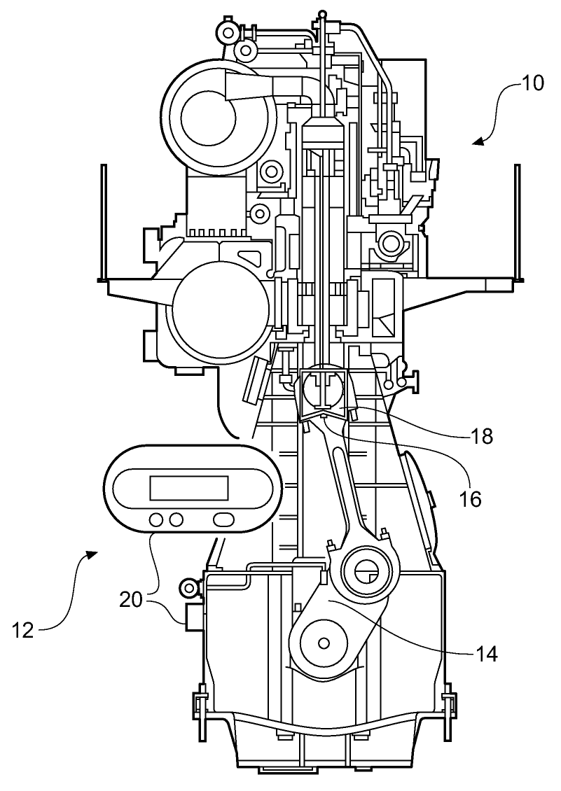

This invention concerns apparatus for monitoring wear in an engine; a method for detecting wear in an engine; particularly but not exclusively apparatus and a method for monitoring bearing wear in engines, and especially in two stroke engines such as large marine engines.

It is generally difficult to monitor bearing wear in engines such as large two stroke marine engines. To date oil mist detection and/or bearing temperatures have been monitored. These do not provide advance notice of bearing failure, nor an indication of which bearings may be wearing. This can result in catastrophic bearing failure requiring a major overhaul, including for instance regrinding of a crank, which can lead to a significant downtime for the engine. Prior warning of wear can allow preventative maintenance. These points also apply to other engines such as four stroke engines and/or reciprocating compressors as used in gas compressors.

According to the present invention there is provided apparatus for monitoring wear in an engine, which engine has a movable component repeatedly movable in use along a movement path, the apparatus including a sensor assembly for detecting the location of the movable component at a particular point on the movement path, and a comparison assembly which compares the detected location of the component at said point on the movement path relative to previously detected locations of the movable component at said point on the movement path.

The component may be reciprocally movable.

The apparatus may detect wear in one or more bearings of the engine. The apparatus may detect the location of a guide shoe of an internal combustion engine. The apparatus may detect the location of a guide shoe of an internal combustion engine at the bottom dead centre point on the movement path of the guide shoe.

The sensor assembly may include a proximity sensor for detecting the location of the movable component. The sensor assembly may include a plurality of proximity sensors. The proximity sensors may be arranged such that the sensor assembly can, when wear is detected, determine from the relative readings of the proximity sensors which part or parts of the engine may have worn.

The comparison assembly may be arranged to enable the rate of wear to be detected.

The apparatus may be arranged to provide a condition message when a predetermined amount of wear is detected.

The apparatus may be arranged to provide a condition message when a predetermined rate of wear is detected.

An alarm may be provided which is actuated when wear above a predetermined level is detected.

The engine may be any of a two stroke internal combustion engine, four stroke internal combustion engine, or compressor.

The sensor assembly is preferably arranged to receive indications of any of the engine speed, load and temperature, and to compensate the detected location of the movable component relative to previously recorded values.

The invention also provides a method for monitoring wear in an engine which engine has a movable component repeatedly movable in use along a movement path, the method including detecting the location of the movable component at a particular point on the movement path, and comparing the detected location relative to previously detected locations of the movable component at said point on the movement path.

A condition message may be produced when a predetermined amount of wear is detected.

A condition message may be produced when a predetermined rate of wear is detected.

The invention also provides a method of detecting bearing wear in an engine, the method including monitoring wear in an engine which engine has a movable component repeatedly movable in use along a movement path, the method including detecting the location of the movable component at a particular point on the movement path, and comparing the detected location relative to previously detected locations of the movable component at said point on the movement path.

The method preferably also includes measuring any of the engine speed, load and temperature, and compensating the detected location of the movable component in the light of previously recorded values.

An embodiment of the present invention will now be described by way of example only and with reference to the accompanying drawing which diagrammatically shows a cross sectional view of an engine fitted with apparatus according to the present invention.

The drawing shows a large two stroke internal combustion engine 10 suitable for use in marine applications. Where monitoring apparatus 12 is fitted to the engine 10 the apparatus 12 includes two proximity sensors 14, only one of which is visible in the drawing, which detect the presence of a target plate 16 mounted on the underside of the guide shoe 18. The sensors 14 are arranged to detect the position of the target plate 16 when the guide shoe 18 is at bottom dead centre of its stroke. The proximity sensor 14 is connected to an electronic processor 20 for processing the signals from the sensors 14.

By comparing the detected location of the guide shoe 18 at bottom dead centre of its stroke, relative to previously detected locations, it is possible to determine when wear of bearings is occurring, and also the rate of wear. The thickness of the material of such bearings can typically be in the range of 1 to 2.5 mm, such that wear can be accurately monitored before failure thereof. The provision of two proximity sensors means that by comparison of the relative measurements it is possible to differentiate between wear of different bearings, and in particular the main bearing, cross-head bearing and crank-pin bearing.

It is to be realised that apparatus 12 would be provided in each cylinder of the engine 10. Through the use of the multiple sensors it is possible to differentiate whether the failed or failing bearing is a main bearing or a cross-head or crank-pin bearing. For instance, if a main bearing were to fail, then the position of the guide shoes in the cylinders on either side of the failed bearing would be impacted. In contrast, if the fault indication is provided on one cylinder only, this will be due to either a crank-pin or cross-head bearing failure in that cylinder.

By measuring the location of the guide shoe 18 at bottom dead centre, it is possible to detect the amount and rate of wear. When this is above a predetermined level a condition message can be provided, and if necessary an alarm provided. If gradual wear is occurring this can be built into the maintenance schedule of the engine to ensure that the bearing is replaced or repaired as appropriate within an appropriate time frame. If rapid wear is occurring an appropriate measure can be taken such as for instance closing the engine down for emergency maintenance prior to total failing of the wear which could be catrostrophic and require a major overhaul of the engine and consequently significant downtime. Obviously such catrostrophic occurrences can be very inconvenient if not dangerous in marine environments.

As well as simply detecting the position of the target plate 16, the apparatus 12 also provides for input of the engine temperature, speed and load. These features can then be compensated relative to previous readings. When the apparatus 12 is installed, calibration will be provided with different engine temperatures, speeds and loads, to enable these features to be compensated for in subsequent use.

The apparatus therefore provides for accurate monitoring of wear in three major bearings of an internal combustion engine. The apparatus is able to discriminate between main bearing failure, and failure of the crank-pin and cross-head bearings. The apparatus permits repeatable and accurate measurements by compensating for environmental and engine load impacts.

It is to be realised that apparatus and methods according to the invention could be used in a wide range of engines. For instance the system could be used in four stroke diesel engines. In such applications any bearing failure is likely to occur quite rapidly, and the system could thus be used to provide an emergency shut down, rather than be used as a predictive maintenance tool. Other uses could be for example in reciprocating compressors, as used in gas compression applications.

Various other modifications may be made without departing from the scope of the invention. In many instances a target plate may not be required, and the position of the guide shoe itself may be detected. A different number and/or arrangement of proximity sensors could be provided. The system could be arranged to provide for automatic shut down in the event of bearing failure.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus for monitoring wear in an engine, which engine has a movable component repeatedly movable in use along a movement path, the apparatus including a sensor assembly for detecting the location of the movable component at a particular point on the movement path, and a comparison assembly which compares the detected location of the component at said point on the movement path relative to previously detected locations of the movable component at said point on the movement path.

2. Apparatus according to claim 1, wherein the sensor assembly includes a proximity sensor for detecting the location of the movable component.

3. Apparatus according to claim 2, wherein the sensor assembly includes a plurality of proximity sensors arranged such that the sensor assembly can, when wear is detected, determine from the relative readings of the proximity sensors which part or parts of the engine have worn.

4. Apparatus according to claim 1, wherein the comparison assembly is arranged to enable the rate of wear to be detected.

5. Apparatus according to claim 4, wherein the apparatus may be arranged to provide a condition message when a predetermined rate of wear is detected.

6. Apparatus according to claim 1, wherein the apparatus is arranged to provide a condition message when a predetermined amount of wear is detected.

7. Apparatus according to claim 6, wherein an alarm is provided which is actuated when wear above a predetermined level is detected.

8. Apparatus according to claim 1, wherein the sensor assembly is arranged to receive indications of any of the engine speed, load and temperature, and to compensate the detected location of the movable component relative to previously recorded values.

9. Apparatus for monitoring wear in one or more bearings of an internal engine, which engine has a guide shoe reciprocally movable in use along a movement path, the apparatus including a sensor assembly for detecting the location of the guide shoe at a particular point on the movement path, and a comparison assembly which compares the detected location of the guide shoe at said point on the movement path relative to previously detected locations of the guide shoe at said point on the movement path.

10. A method for monitoring wear in an engine which engine has a movable component repeatedly movable in use along a movement path, the method including detecting the location of the movable component at a particular point on the movement path, and comparing the detected location relative to previously detected locations of the movable component at said point on the movement path.

11. A method according to claim 10, wherein a condition message is produced when a predetermined amount of wear is detected.

12. A method according to claim 10, wherein a condition message is produced when a predetermined rate of wear is detected.

13. A method of detecting bearing wear in an internal combustion engine, which engine has a guide shoe reciprocally movable in use along a movement path, the method including detecting the location of the guide shoe at a particular point on the movement path, and comparing the detected location relative to previously detected locations of the guide shoe at said point on the movement path.

14. A method according to claim 13, wherein the apparatus detects the location of the guide shoe at the bottom dead centre point on the movement path thereof.

15. A method according to claim 13, wherein the method also includes measuring any of the engine speed, load and temperature, and compensating the detected location of the guide shoe in the light of previously recorded values.
